(19) United States
(12) Patent Application Publication
(10) Pub. No.: US 2022/0302485 A1
(43) Pub. Date: Sep. 22, 2022

(54) ZINC AIR FUEL CELL FOR RENEWABLE AND SUSTAINABLE ENERGY

(71) Applicants: Joel Steven Goldberg, Hillsborough, NC (US); Alexander Magna Bhatt, Stanford, CA (US)

(72) Inventors: Joel Steven Goldberg, Hillsborough, NC (US); Alexander Magna Bhatt, Stanford, CA (US)

(21) Appl. No.: 17/575,735

(22) Filed: Jan. 14, 2022

(51) Int. Cl. H01M 8/083; H01M 4/90; H01M 4/96

(52) U.S. Cl. CPC H01M 8/083; H01M 4/9041; H01M 4/96; H01M 2300/0014

(57) ABSTRACT

This invention describes a sustainable, renewable, and inexpensive process to produce electrical energy with zinc air fuel cells (ZAFC) not comprised of a corrosive alkaline electrolyte. The cell's zinc hydroxide waste product is reduced to zinc metal by heat from carbothermal solar concentration. Further research to improve the efficiency of the electrode design and improve zinc oxide reduction is encouraged. The benefits of ZAFC as a primary source of electricity to include underdeveloped countries is discussed.

### CROSS-REFERENCES TO RELATED APPLICATIONS

None

### FEDERALLY FUNDED RESEARCH

Not applicable

### BACKGROUND OF THE INVENTION

Traditional zinc air fuel cells (ZAFC) are comprised of a zinc anode, a carbon cathode usually graphite, and an alkaline electroltye. The carbon cathode and alkaline electrolyte in these cells are typically graphite and potassium hydroxide (KOH), respectively. These cells operate at an approximate pH of 13. The alkaline electrolyte is preferred because the zincate species is maximum at this pH, and the zincate precipatates into zinc oxide (ZnO). (FIG. 1) The alkaline electrolyte increases the cell's current density. The chemistry of this fuel cell is:
Anode: Zn+4OH⁻→Zn(OH)₄²⁻+2e⁻ (E⁰=1.25 V)
Zn(OH)₄²⁻→ZnO+H₂O+2OH⁻
Cathode: ½O₂+H₂O+2e⁻→2OH⁻ (E⁰=0.34 V, pH=13)
Overall: Zn+½O₂→ZnO (E⁰=1.59 V)
Best practices E=1.3 volts

Problems associated with traditional ZAFC include:
1. The KOH electrolyte poisons ZAFC as a renewable and sustainable source of energy as it is corrosive, expensive, and polluting. When ZAFC and KOH electrolytes are exposed to the atmosphere, insoluable K₂CO₃ deposits on the cathode, impeding oxygen access and impairing cell performance. The chemical reactions that describe this carbonation reaction are:

CO₂+OH⁻→HCO₃⁻

HCO₃⁻+OH⁻→CO₃²⁻+H₂O
2. Dendritic growth of zinc can occur on the anode, which can short circuit the cell and change the anode shape. This results in loss of cell capacity.
3. The hydrogen evolution reaction (HER) at the anode decreases the longevity of ZAFC. The chemical reaction that describes this process is:

Zn+2H₂O→Zn(OH)₂+H₂

For ZAFC to be environmentally friendly and sustainable, the KOH electrolyte needs to be replaced. Prior work demonstrates that this electrolyte can be replaced with an aqueous solution of sodium chloride or seawater while still maintaining cell longevity.[1, 2]

ZAFC with saline electrolytes are long lived. Though previous work suggested that zinc hydroxychlorides form in the process, more recent data suggests that sodium chloride does not directly participate in the cell chemistry. Furthermore, there is no evidence of chlorine gas or Na₂CO₃ formation at the cathode. The proposed chemistry of these ZAFC is:
Anode: Zn→Zn⁺²+2e-(E⁰=0.76 V)
Fluid: Zn⁺²+2OH⁻Zn(OH)₂
Cathode: ½O₂+H₂O+2e⁻→2OH⁻ (E⁰=0.40 V, pH˜10)
Overall: Zn+½O₂+H₂O→Zn(OH)₂ (E⁰=1.16 V)
Best practices E=0.65 volts at pH˜10

This invention extends previous work on ZAFC and demonstrates that ZAFC, comprised of zinc, graphite, and an aqueous solution of sodium chloride, are inexpensive, renewable and sustainable. These ZAFC can provide primary electrical energy. They can be constructed locally at homes, businesses, and government facilities.

### DRAWINGS

FIG. 1 shows the ionic species of zinc at various pH values. At pH˜10, the most abundant zinc species is Zn(OH)₂.

FIG. 2 is an Ellingham diagram of reduction of ZnO with C. −ΔG₁° for the reduction of Zn is labeled 1. Labeled 2 is ΔG₂° for the oxidation of C. The equilibrium point for the oxidation reduction (−ΔG₁° +ΔG₂°=0) is labeled 3, which corresponds to a temperature of approximately 1000° C. The temperature needs to be greater than 1000° C. for the reduction of ZnO with C at atmospheric oxygen tension.

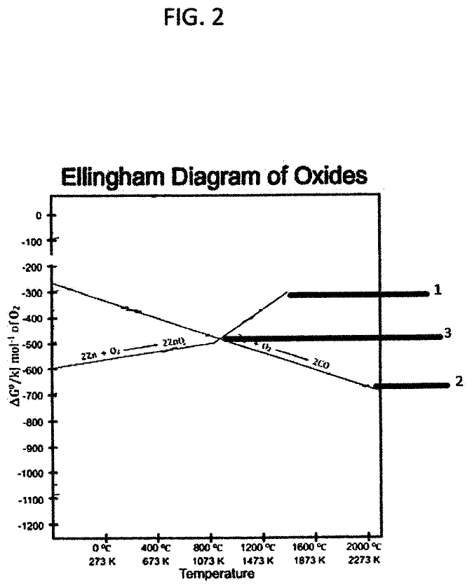

### DETAILED DESCRIPTION OF THE INVENTION

Many investigators agree that metal air fuel cells are not a feasible, sustainable, nor renewable energy source.[3] The process is considered too expensive. Our recent work presents evidence that zinc air fuel cells (ZAFC) may be a sustainable and an economical source of electricity. ZAFC have several characteristics that distinguish them from other traditional energy sources:
1. ZAFC are not subject to Carnot inefficiencies of converting heat to work that is inherent in all nuclear, fossil fuel, and solar concentration systems that generate steam.
2. Unlike solar, wind, and some hydroelectric systems, ZAFC are not dependent on weather conditions.
3. ZAFC are simple to engineer. They can be constructed at local businesses and residences, and avoid powerline transmission.
4. ZAFC may be protected from electromagnetic pulses.
5. ZAFC consume oxygen and zinc. The zinc is oxidized as a fuel and can be reduced to zinc metal with concentrated solar sustainable heat. [4, 5] Unlike many other metals, the low boiling point of zinc produces zinc vapor that can be condensed to pure zinc. It is proposed that the novel ZAFC described in this invention consumes water.
6. ZAFC can efficiently operate at a pH of approximately 10 without corrosive electrolytes.
7. ZAFC can be organized in series and parallel to increase electrical output.
8. ZAFC can be made more efficient by increasing surface areas of the anode and cathode.

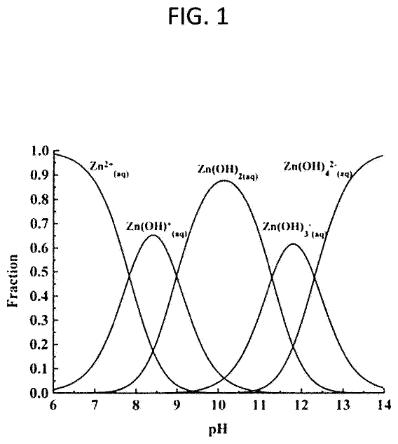

Previous work has shown that a zinc air fuel cell comprised of a zinc anode, a graphite cathode, and electrolyte of saturated sodium chloride aqueous solution can produce a fuel cell with increased longevity. This ZAFC produced 193Wh/kg of electricity with a duration greater than 320 days.[6] This longevity was the result of a slowly increasing ionic resistance. In these ZAFC, Zn(OH)₂ was the primary precipitate, and the average pH is 10. [2] The realization that saturated sodium chloride in the ZAFC does not produce significant quantities of zinc hydroxychlorides is fortuitous as the sodium chloride electrolyte in ZAFC does not participate in the redox reactions. This assertion is in agreement with recent studies. [7] Therefore, the major waste product is Zn(OH)₂ which makes reduction simpler than having to consider the chloride salts. We have reached this conclusion based upon the white flocculent characteristic of the precipitate, the approximate pH of 10, and the EMF of the cell around 0.6-0.7 volts. (FIG. 1) Furthermore, the white precipitate becomes slightly yellow when heated, and the pH of this substance in water is 7.6. This corresponds to the decomposition of Zn(OH)₂ to ZnO+H₂O.

These ZAFC cells operate without a corrosive electrolyte such as KOH. [8] The proposed chemistry of these previously described ZAFC fundamentally differs from traditional ZAFC:
Anode: Zn→Zn⁺²+2e-(E⁰=0.76V)
Fluid: Zn⁺²+2OH⁻→Zn(OH)₂
Cathode: ½O₂+H₂O+2e⁻→2OH⁻ (E⁰=0.40 V, pH˜10)
Overall: Zn+½O₂+H₂O→Zn(OH) (E⁰=1.16 V)
Best practices E=0.65 volts at pH˜10

This invention describes the economic feasibility of ZAFC as a primary energy source. In order for these fuel cells to be an acceptable and competitive source of electricity, they need to be dependable, economical, and environmentally friendly. A dependable cell will be durable when the waste products of the cell are efficiently managed. The most concerning waste product in ZAFC is the hydroxide ions produced at the cathode from the reduction of oxygen. In the traditional alkaline fuel cell, this OH⁻ combines with zinc to form Zn(OH)₄²⁻ which eventually forms ZnO. The chemistry of previously describe ZAFC fundamentally differs from traditional fuel cells, because the OH⁻ waste is either adsorbed onto micropores within charcoal or bituminous coal or combined with the zinc ion to produce Zn(OH)₂.[2, 9] Unfortunately, the micropore adsorption properties for OH⁻ were not consistent and predictable. The operating pH is approximately 10. The cell does not utilize a corrosive alkaline electrolyte such as KOH, and carbonate production from soluble atmospheric CO₂ is not apparent. The cell does not generate hydrogen at the anode or suffer from zinc dendritic growth. The electrolyte of sodium chloride is environmentally friendly and can be recycled. Previously described formation regarding zinc hydroxychlorides in ZAFC comprised of a saturated sodium chloride solution is not proposed as a primary reaction of the cell [2, 6]

The obstacles to commercialization of ZAFC as a primary energy source are cultural and economic. The ZAFC provides DC current unlike standard AC current which powers nearly all lights, appliances, and machinery. The oxidized zinc, the most expensive waste component of the ZAFC, needs to be economically reduced to pure metal for recycling. New advances in solar carbothermal reduction suggest that this reduction is possible and environmentally sustainable.[4]
Reduction of Zn(OH)₂ to Zn

The waste product of Zn(OH)₂ in ZAFC readily precipitates, and it is easily separated from the sodium chloride electrolyte and any other aqueous components. It is filtered and washed. In the thermal reduction of Zn(OH)₂, Zn(OH)₂ rapidly converts to ZnO at low temperatures, after which the ZnO is reduced with CO to Zn(g) which condenses to Zn(s). The CO is produced with renewable charcoal and oxygen.

With solar concentration technology, the regeneration of zinc metal from Zn(OH)₂ is environmentally favorable and sustainable. Even if traditional fossil or electrical sources of heat were required to supplement the solar concentration, the process would still be a significant improvement over standard ZnO smelting technologies. The entire process is renewable and sustainable. The sodium chloride solution can be recycled along with the graphite electrode.

Table 1 shows some important temperatures achieved with concentrated solar energy. Table 2 shows some important temperatures required for the reduction of ZnO to Zn.

Previous work has shown that temperatures required to reduce iron oxide to iron without carbon can be significantly decreased from approximately 1600 C.° to 1200 C.° under low oxygen pressure in a platinum crucible, presumably with a platinum catalyst. [10] Whether such conditions will decrease the critical temperature for reduction of ZnO is not known. Clearly, reducing oxygen tension will favor Zn reduction, but with decrease CO production. At the present time, a catalyst has not been described to lower the temperature for ZnO reduction.

TABLE 1
Temperatures achieved with concentrated solar energy

| | Temperature ° C. |
|---|---|
| Solar concentration-Valparaiso University | 1650 |
| Solar concentration-SOLZINC | 1200 |
| Solar concentration -Rehovot, Israel | 1200 |
| Solar concentration-PSA, Spain | 1000 |

TABLE 2
Temperatures for reduction of ZnO to Zn

| | Temperature ° C. |
|---|---|
| Vaporization of Zinc | 950 |
| Reduction of ZnO to Zn with Carbon | 1000-1100 |
| Reduction of ZnO to Zn with Carbon, | unknown |
| Decreased Oxygen Tension | |
| Reduction of ZnO to Zn with Carbon, | unknown |
| Decreased Oxygen Tension, Catalyst | |

### Experimental Section

One group of ZAFC was comprised of a zinc anode(21g, 0.25″rod, Rotometals, USA), a saturated solution of sodium chloride in well water, graphite cathode (12g, 10mm rod, Walfront, USA) and glass separating the anode from the cathode. Another group of ZAFC was comprised of a zinc anode, a saturated solution of sodium chloride in well water, graphite cathode, glass separating the anode from the cathode, and a cube of coconut charcoal (14g, 25mm³, M.Rosenfeld, Germany). The ZAFC were connected to a 1K ohm resistor, and the voltage, current, and pH were measured at biweekly intervals. (Table 3)

TABLE 3
Comparison of ZAFC with and without charcoal

| | ZAFC without charcoal | ZAFC with charcoal |
|---|---|---|
| Day | v, ma, pH | v, ma, pH |
| 1 | .623, .592, 8.8 | .604, .567, 8.2 |
| 15 | .617, .580, 10.15 | .651, .600, 10.14 |
| 30 | .660, .570, 10.29 | .650, .610, 10.54 |
| 45 | .582, .544, 10.28 | .628, .580, 10.24 |

### Results

There may be some improved performance of ZAFC with addition of charcoal from Zn⁺² adsorption. The charcoal can be further used to reduce ZnO.

### Benefits to Society

As discussions and repercussions related to global climate change continue to exacerbate, there is an urgent need to produce economical, sustainable, and renewable electricity. This invention describes a process that meets these requirements. However, the paradigm shift from decentralized AC electric transmission to localized DC electric with ZAFC will not be easily accepted. The costs and savings of such a shift are difficult to estimate. Obsolete transmission lines, protection from electromagnetic pulses, and elimination of nuclear and fossil fuels with significant lowering of carbon emissions are just some of the accepted benefits of ZAFC for primary electricity. Replacing KOH, the present-day preferred electrolyte in ZAFC, with NaCI or seawater is needed. Based on these considerations, energy research expenditures should allocate more funds to improve reduction of ZnO with concentrated solar energy and improve the electrode design of the ZAFC. This system of ZAFC could provide subsistence electricity for underdeveloped populations. This invention presents a path for future production of electricity, and many improvements along this path are expected in order to bring this technology to fruition.

### REFERENCES

1. Jackovitz, J. F., Zuckerbrod, D., Buzzelli, E. S., SEAWATER POWER CELL U.S. Pat. No. 4,822,698, 1989, USPTO.
2. Goldberg, J. S., NOVEL ZINC AIR FUEL CELL WITH LONGEVITY US 2019/0296409A1, 2019, USPTO.
3. Bhatt, A. M. Current Infeasibility of Metals as a Clean Fuel Source. Stanford Univeristy, 2020.
4. SOLZINC: Storing Solar Energy in Zinc for Eectricity or Hydrogen Production. www.greencarcongress.com, 2005.
5. Solar Carbothermic Production of Zinc and Power Production Via a Zno-Zn Cyclic Process. Proceedings ISES 2003, Goteborg, June14-19, 2003, 2003.
6. Goldberg, J. S., (LOSE-LOSE)-WIN RESOLUTION OF CONFLICT US 2020/0349667A1, 2020, USPTO.
7. Meng, Y., et al., Initial formation of corrosion products on pure zinc in saline solution. Bioact Mater, 2019. 4(1): p. 87-96.
8. Chen, P., et al., Recent Progress in Electrolytes for Zn-Air Batteries. Front Chem, 2020. 8: p. 372.
9. Goldberg, J. S., RENEWABLE, RECHARGEABLE, INEXPENSIVE ZINC/NATURAL CARBON/GRAPHITE AIR FUEL CELL US2015/0037709A1, 2015, USPTO.
10. Sosman, R. B., Hostetter, J. C., The reduction of iron oxides by platinum, with a note on the magnetic susceptibility of iron-bearing platinum. Journal of the Washington Academy of Sciences, 1915. 5: p. 293-303.

Having described our invention, we claim:

1. A method to produce sustainable, renewable, economical electricity utilizing a zinc air fuel cell comprised of:
a. a zinc anode, a graphite cathode, an electrolyte of sodium chloride, and a non-conductive substance that separates the zinc anode from the graphite anode
b. a separation of a zinc hydroxide precipitate from the electrolyte
c. a reduction of the precipitate with a solar concentration device to a metal comprised of zinc.
d. a reconstruction of the cell with said cathode, said electrolyte, said non-conductive substance and said zinc.

2. The method of claim 1, where the zinc air fuel cell is comprised of a zinc anode, a graphite cathode, an electrolyte of a solution of sodium chloride, a substance that separates the zinc anode from the graphite anode, and a substance comprised of charcoal.
